(19) United States
(12) Patent Application Publication
(10) Pub. No.: US 2025/0389650 A1
(43) Pub. Date: Dec. 25, 2025

(54) CAVITY ENHANCED GAS SENSOR AND SENSING METHODS

(71) Applicant: INTEGRITY COMMUNICATIONS SOLUTIONS, INC., Colorado Springs, CO (US)

(72) Inventors: Graeme TOWNDROW, Colorado Springs, CO (US); Michael TIPTON, Florissant, CO (US); Troy POWELL, Colorado Springs, CO (US); Thomas GROUNDS, Woodland Park, CO (US); Sydney AWID, Colorado Springs, CO (US); Kevin YOUNG, Colorado Springs, CO (US)

(21) Appl. No.: 19/244,228

(22) Filed: Jun. 20, 2025

Related U.S. Application Data
(60) Provisional application No. 63/662,904, filed on Jun. 21, 2024.

(51) Int. Cl. G01N 21/3504

(52) U.S. Cl. CPC G01N 21/3504; G01N 2201/062; G01N 2201/0636

(57) ABSTRACT

Apparatuses, systems, and methods for a cavity enhanced absorption gas sensor. The gas sensor includes a sample chamber with a first reflector at a first end of the sample chamber and a second reflector at a second end of the sample chamber. The first and the second reflector form an optical cavity within the sample chamber. The sensor includes an illumination source which passes light through the first reflector and into the sample chamber and a detector which receives light from the sample chamber through the second reflector. This may increase an effective optical path length of the sensor and lower the limit of detection of the sensor.

### CROSS-REFERENCE TO RELATED APPLICATIONS

This application claims the benefit of priority pursuant to 35 U.S.C. § 119(e) of U.S. Provisional Patent Application No. 63/662,904, filed Jun. 21, 2024, entitled “Cavity Enhanced Gas Sensor and Sensing Methods,” which is hereby incorporated by reference herein in its entirety.

### TECHNICAL FIELD

Embodiments of the invention relate generally to gas sensing, and particularly, to non-dispersive infrared detectors.

### BACKGROUND

There are a variety of applications where it is useful to monitor a concentration of one or more target gases in an environment. For example, there is growing interest in environmental monitoring of greenhouse gases or other pollutants which may be released from sites such as wellsites, industrial facilities, pipelines, and so forth. For many of these applications, it may be useful to detect relatively low concentrations of the target gas(es).

Spectroscopy offers a useful approach for sensing the concentration of a chosen target gas, as it can be specific to a target gas even in a mix of other gases, and can be implemented with a range of optical components. A spectroscopic sensor may hold a sample of gas in a sample chamber and pass light through the gas to a detector. Since the limit of detection of the target gas may be partially dependent on the length of the path(s) the light takes through the sample chamber, it may be useful to design the sample chamber to increase the effective path length in order to increase detectability of low concentrations of the target gas.

### SUMMARY

In at least one aspect, the present disclosure relates to an apparatus including a first reflector, a second reflector, a sample chamber positioned between the first reflector and the second reflector which holds a sample gas, an illumination source which directs light through the first reflector and into the sample chamber, and a detector which receives light from the sample chamber through the second reflector. At least a portion of the received light has reflected through the sample chamber between the first and the second reflector one or more times.

The first reflector may have a higher reflectivity than the second reflector. The first reflector may have a first side facing the illumination source and a second side facing the sample chamber, where the first side has an anti-reflective coating and the second side has a highly reflective coating. The apparatus may include a lens positioned between the second reflector and the detector.

The apparatus may include an illumination circuit board having a first side and a second side. The illumination circuit board holds the illumination source on the second side. The apparatus may include a first manifold positioned on the first side of the illumination circuit board and a second manifold positioned on the second side of the illumination circuit board. At least one passage through the illumination circuit board fluidly couples the first manifold to the second manifold and wherein the second manifold is fluidly coupled to an interior of the sample chamber. The apparatus may include a detector circuit board having a first side and a second side. The detector circuit board holds the detector on a first side. The apparatus may include a first manifold positioned on the first side of the detector circuit board and a second manifold positioned on the second side of the detector circuit board. At least one passage through the detector circuit board fluidly couples the first manifold and the second manifold, and wherein the first manifold is fluidly coupled to an interior of the sample chamber.

The apparatus may include a controller which measures a concentration of a target gas in the gas sample based on the received light at the detector. The target gas may be methane. The apparatus may be a non-dispersive infrared sensor.

In at least one aspect, the present disclosure relates to an apparatus which includes a sample chamber, an illumination carrier and a detector carrier. The illumination carrier includes a first manifold, a second manifold, a first substrate which holds an illumination source and has passages configured to fluidly couple the first manifold to the second manifold, and a first reflector positioned between the second manifold and the sample chamber, where passages in the illumination carrier fluidly couple the second manifold to an interior of the sample chamber. The detector carrier includes a third manifold, a fourth manifold, a second substrate which holds a detector, the second substrate having passages configured to fluidly couple the third manifold to the fourth manifold, and a second reflector positioned between the third manifold and the sample chamber, where passages in the detector carrier fluidly couple the third manifold to the interior of the sample chamber.

The apparatus may include a first port fluidly coupled to the first manifold and a second port fluidly coupled to the second manifold. The detector carrier may include a lens positioned between the second reflector and the detector. The first reflector and the second reflector may form an optical cavity along the sample chamber. The illumination source may direct light through the first reflector and into the interior of the sample chamber and the detector may receive light through the second reflector from the sample chamber. The illumination source may be a light emitting diode. The detector may be a photodiode, a photomultiplier tube, or an avalanche photodiode.

The apparatus may include at least one sensor on the first substrate, the second substrate, or combinations thereof. The least one sensor measures temperature, pressure, humidity, or combinations thereof. The apparatus may include a controller in electrical communication with the detector. The controller may determine a concentration of a target gas in the sample chamber based on the received portion of the illumination light.

The illumination carrier may include a first illumination carrier component, a second illumination carrier component, a first seal positioned between the first illumination carrier component and the first substrate, and a second seal positioned between the second illumination carrier component and the first substrate. The first manifold is formed between the first illumination carrier component and the first substrate and the second manifold is formed between the first substrate and the second illumination carrier component. The detector carrier may include a first detector carrier component, a second detector carrier component, a first seal positioned between the first detector carrier component and the second substrate, and a second seal positioned between the second detector carrier component and the second substrate. The third manifold is formed between the first detector carrier component and the second substrate, and the fourth manifold is formed between the second substrate and the second detector carrier component.

In at least one aspect, the present disclosure relates to a method including directing light from an illumination source through a first reflector and into a sample chamber containing a gas sample, receiving light at a detector through a second reflector which is at an opposite end of the sample chamber from the first reflector, and measuring a concentration of a target gas in the gas sample based on the light received by the detector.

At least a portion of the received light may have been reflected between the first reflector and the second reflector one or more times. The method may include measuring additional properties of the gas sample with one or more sensors, where the additional properties include temperature, pressure, humidity, or combinations thereof. The method may include measuring the gas concentration based, in part, on the additional properties. The method may include collecting the gas sample from a suspected emission source and determining if the suspected emission source is emitting the target gas based on the measured concentration. The method may include measuring a concentration of methane as the target gas.

The method may include receiving the gas sample through a first port in a first manifold, passing the gas sample through a circuit board which supports the illumination source to a second manifold, passing the gas sample from the second manifold into an interior of the sample chamber and from the interior of the sample chamber into a third manifold, passing the gas sample from the third manifold through a second circuit board which supports the detector to a fourth manifold, and exhausting the gas sample through a second port from the fourth manifold. The method may include reporting the measured concentration of the target gas to an external system,

### BRIEF DESCRIPTION OF THE DRAWINGS

FIG. 1 is a cross-sectional diagram of a measurement system according to some embodiments of the present disclosure.

FIG. 2 is a cross-sectional diagram of a flow-through gas sensor with cavity enhancement according to some embodiments of the present disclosure.

FIG. 3 is a cross-sectional schematic of an example flow-through gas sensor with cavity enhancement according to some embodiments of the present disclosure.

FIGS. 4A and 4B are perspective views of an illumination carrier and portion of a sample chamber according to some embodiments of the present disclosure.

FIGS. 5A and 5B are perspective views of a detector carrier and portion of a sample chamber according to some embodiments of the present disclosure.

FIG. 6 is a flow chart of a method of operating a cavity enhanced gas sensor according to some embodiments of the present disclosure.

FIG. 7 is a perspective view of an in-line sensor according to some embodiments of the present disclosure.

FIG. 8 is a cross-sectional schematic of an example flow-through gas sensor with cavity enhancement according to some embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Optical gas sensors, such as non-dispersive infrared (NDIR) sensors, use light to measure a concentration of one or more target gases in a gas sample. The sensor may generally operate based on spectroscopic principles such as the Beer-Lambert law to measure a concentration of gas between a source and a detector. The gas sample may be held in a sample container with the source at one end and the detector at the other. The ability to measure the target gas in the sample chamber may be based, in part, on an optical path length between the light source and the detector. In order to achieve the lowest possible limit of detection it may be desirable to increase the optical path length. However, it may be impractical or otherwise undesirable to increase the physical distance between the source and detector.

The present disclosure is related to apparatuses, systems and methods for cavity enhanced gas sensing. In an example gas sensor of the present disclosure, the sample chamber is positioned between two reflectors, such as mirrors, of high reflectivity which form an optical cavity. The source passes light through the first reflector and into the cavity, and the detector receives light which passes through the second reflector out of the cavity. The cavity is filled with the sample gas and the light within the cavity is reflected back and forth between the first and the second reflector. As the light reflects off the second reflector, a portion may exit and reach the detector. In this manner, the effective path length between the source and the detector is increased based on the reflections of the light back and forth within the optical cavity. This may allow the senor to detect relatively low concentrations of the target gas, since the long optical path length allows for more interaction between the light and molecules of the target gas.

In some example embodiments, the cavity enhanced gas sensor may be a flow-through gas sensor or in-line gas sensor. The flow-through gas sensor includes an illumination carrier and detector carrier coupled with the sample chamber between them. The sample chamber is positioned between two reflectors, which form ends of the sample chamber. The illumination carrier includes the source. The detector carrier includes the detector. The two reflectors may be housed in the illumination and detector carriers, or may be in separate carriers. The illumination carrier also has a port (e.g., an inlet/outlet) on a backside (e.g., the side facing away from the interior of the sample chamber) which is coupled through the illumination carrier to the interior of the sample chamber. Similarly, the detector carrier has a port on a backside coupled through the carrier to the interior of the sample chamber. The ports are fluidly coupled through their respective carriers into the sample chamber. For example, the illumination carrier may include a first manifold which is fluidly connected through ports in an illumination substrate (e.g., a circuit board, a bread board, or other substrate that supports electronics) which supports the illumination source to a second manifold. The second manifold is fluidly coupled through ports past the reflector and into the sample chamber. Similarly, the sample chamber may be fluidly coupled through ports past the second reflector into a third manifold which is fluidly coupled through ports in a detector substrate that supports the detector into a fourth manifold. In this manner, the sample gas may flow past the source and first reflector into the sample chamber and then past the second reflector and detector out of the sensor (or vice-versa). This geometry may be convenient, for exampling, allowing the sensor to be positioned in-line with a pipe carrying the sample gas.

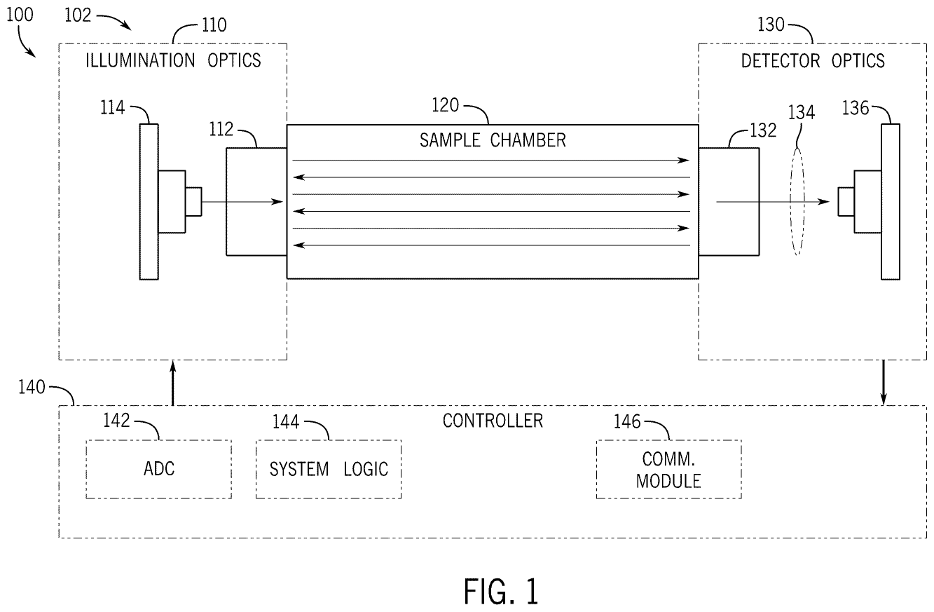

FIG. 1 is a cross sectional diagram of a measurement system according to some embodiments of the present disclosure. The measurement system 100 includes a cavity enhanced sensor 102 or cavity enhanced sensor assembly, along with an optional controller 140, which supports the operation of the sensor 102. The sensor 102 includes a sample chamber 120 which includes a sample gas, illumination optics 110 and detector optics 130. The illumination optics 110 include a source 114 which directs light through a reflector 112 and into the sample chamber 120. The detector optics 130 include a second reflector 132 which reflects light back and forth with the first reflector 112, forming an optical cavity. Light which passes through the second reflector 132 passes through an optional lens 134 to a detector 136 which measures or detects the received light. A concentration of one or more target gases within the gas sample is measured based on the detected received light at the detector 136.

Absorption of light passing a distance d through a gas is generally given by the Beer-Lambert law, given by Equation 1, below:

$$\frac{I}{{I}_{0}} = {e}^{- ρσ d} \qquad Eqn . 1$$

Where I₀ is the initial beam intensity, I is the intensity after light passes through the gas, d is the distance the light passes through the gas, ρ is the number density of the absorbing gas, and σ is the absorption cross section of the absorbing gas. As the path length d increases, the amount of attenuation of the light from the sample gas increases. If the concentration, which is related to the density ρ, is particularly low, then the increased path length allows more attenuation, making it easier to measure the change in intensity.

In the gas sensor 102, the sample chamber 120 between the two reflectors 112 and 132 is filled with the sample gas. The light within the chamber 120 bounces back and forth between the two reflectors 112 and 132. The two reflectors may generally be referred to as mirrors herein and when the term mirror is used herein, it may refer to any form of reflector.

The two reflectors 112 and 132 are not perfectly reflective. The first reflector 112 allows some light to be transmitted through the material of the reflector 112 and pass into the sample chamber 120 and the second reflector 132 allows some light to transmit through the material of the reflector 132 and pass out of the sample chamber 132. As shown by the arrows in FIG. 1, the light passes from the source 114, some portion of the light will pass directly through the cavity, while other light will reflect back and forth one or more times within the sample chamber 120 before exiting to the detector 136. This increases the effective optical path of the light within the gas.

In an example implementation, each reflector 112 and 132 may be a material which is generally transparent and which has an anti-reflective (AR) coating on a side of the reflector facing away from the chamber 120, referred to as the back side of the reflector, and a highly reflective (HR) coating on the side of the reflector facing into the chamber 120, referred to as the front side of the reflector. The AR coating has a transmission coefficient of t₀. Each of the two reflectors 112 and 132 has a reflectivity of r. The light entering the chamber will have an attenuation given by t₀. The light exiting the chamber will have an attenuation given by (1−r) to account for the portion of light which passes through the second reflector 132. If d is the length of the sample chamber 120, such as the distance between the front surfaces of the two reflectors 112 and 132, then for each pass within the sample chamber the light is attenuated by e^{-ρσd} to account for the absorption by the gas and by r² to account for the reflection off the two reflectors 112 and 132. The intensity of light exiting the second reflectors 132 after several example passes is given by Equations 2-4, below:

$$1 pass = {I}_{0} {t}_{0} {e}^{- ρσ d} ( 1 - r ) \qquad Eqns . 2$$

$$3 passes = {I}_{0} {t}_{0} {e}^{- 3 ρσ d} {r}^{2} ( 1 - r ) \qquad Eqns . 3$$

$$5 passes = {I}_{0} {t}_{0} {e}^{- 5 ρσ d} {r}^{4} ( 1 - r ) \qquad Eqns . 4$$

Odd numbers of passes are shown since only the light which reaches the detector will be measured. For example, the light which exits the sample chamber 120 after two passes along the length of the chamber and thus exits back towards the source 112 will not contribute to the light reaching the detector. For example, the light which makes one pass will enter the chamber 120 and exit the chamber without reflecting off either reflector 112 or 132. The light which makes 3 passes will reflect off the second reflector 132, reflect off the first reflector 112, and then transmit through the second reflector 132 to exit the chamber. The total amount of light Iₒᵤₜ which exits the second reflector 132 to reach the detector 136 can be expressed by summing the amount of light which reaches the detector from each number of passes which exits the second reflector 132 as shown in Equation 5, below, where n is an index used to track the number of passes, and 2n−1 representing the passes which contribute to Iₒᵤₜ:

$${I}_{out} = {\sum }_{n = 1}^{∞} {I}_{0} {t}_{0} ( 1 - r ) {e}^{- ( 2 n - 1 ) ρσ d} {r}^{2 n - 1} \qquad Eqn . 5$$

Equation 5 may be solved to give Equation 6, below:

$${I}_{out} = {I}_{0} {t}_{0} ( 1 - r ) \frac{{e}^{ρσ d}}{{e}^{2 ρσ d} - {r}^{2}} \qquad Eqn . 6$$

Equation 6 gives a formula for the amount of light which reaches the detector 136. This is expressed in terms of quantities which are determined by the sensor 102 or the known properties of the target gas. For example, d is a property of the geometry of the sensor 102, I₀ is known based on the operation of the sensor 114, r and t₀ may be found based on the known properties of the reflectors 112 and 132, and σ is a property of the target gas. In some embodiments, one or more additional properties of the gas sample may be measured such as temperature, pressure, humidity, or combinations thereof, and used to more precisely determine a current value of σ. Eqn. 6 may be used to determine the concentration based on a measurement of Iₒᵤₜ, the light reaching the detector 136.

The properties of the reflectors may be chosen to increase the amount of light which is expected to reach the detector. For example, if both reflectors 112 and 132 have a roughly equal reflectivity, then Iₒᵤₜ≈I₀/2. This may be undesirable as it represents a loss of approximately half of the light which is generated by the illumination source 114. However, if the reflectivity of the first reflector 112 is higher than the reflectivity of the second reflector 132, then the light becomes highly forward directed from the source 114 to the detector 136. For example, if the first reflector has a reflectivity of r₁, and the second reflector has a reflectivity of r₂, then Equations 5 and 6 become Equation 7 and 8, respectively, below:

$${I}_{out} = {\sum }_{n = 1}^{∞} {I}_{0} {t}_{0} ( 1 - {r}_{2} ) {e}^{- ( 2 n - 1 ) ρσ d} {r}_{1}^{n - 1} {r}_{2}^{n - 1} \qquad Eqn . 7$$

$${I}_{out} = {I}_{0} {t}_{0} ( 1 - {r}_{2} ) \frac{{e}^{ρσ d}}{{e}^{2 ρσ d} - {r}_{1} {r}_{2}} \qquad Eqn . 8$$

In an example implementation, then if the first reflector has r₁ of 99.97% and the second reflector 132 has r₂ of 99.5%, then about 94.4% of the light will reach the detector (assuming an empty sample chamber). Other reflectivities may be used in other example embodiments.

The illumination source 114 generates light including a measurable amount of radiation at a wavelength with interacts with a target gas. For example, if the target gas is methane, then the illumination source 114 may put out radiation at a wavelength of about 3.3 um. In some embodiments, the illumination source 114 may be a broad band source. In some embodiments, the illumination source 114 may be a narrowband source that primarily outputs radiation at or around a target wavelength. In some embodiments, the illumination source 114 may be an incandescent light, a light emitting diode (LED), a laser, or other component configured to generate the desired radiation. In some embodiments, the illumination optics 110 may include additional optics (not shown in FIG. 1) to condition the light. For example, the illumination optics 110 may include a lens, filter, mirror, or combinations thereof.

The detector 136 generates a signal based on a received amount of light. In some embodiments, the detector 136 may be sensitive to a wide spectrum of light. In some embodiments, the detector 136 may be sensitive to a specific range of wavelengths. The detector 136 may be chosen such that it is sensitive to one or more wavelengths produced by the illumination source 114 and which interact with the target gas. In some embodiments, the detector 136 may be a photodiode, a photomultiplier tube, or an avalanche photodiode.

In some embodiments, the detector optics 130 may include an optional lens 134. The lens may help concentration of the light which exits the second reflector 132 onto the detector 136. This may help ensure that substantially all of Iₒᵤₜ reaches the detector 136 and gets measured. In some embodiments, the detector optics may include one or more additional optics (not shown in FIG. 1) to condition the light which reaches the detector 136. For example, the detector 136 may include a filter, mirror, diffraction grating, additional lenses, or combinations thereof.

In some embodiments, the reflectors 112 and 132 may be implemented as mirrors. For example, the reflectors 112 and 132 may be flat mirrors, with a flat surface positioned towards the sample chamber 120. In some embodiments one or both of the reflectors 112 and 132 may be a plano-concave mirror, with the concave side facing the sample chamber 120. In some embodiments, one or both of the reflectors 112 and 132 may have a coating. For example, the mirror may have an AR coating on the backside and/or an HR coating on the side facing the sample chamber 120. In some embodiments, one or both of the reflectors 112 and 132 may be formed from a silicon substrate or a CaF substrate.

The sensor 102 may be coupled to an optional controller 140, which may operate or at least communication with the sensor 102 and interpret and/or receive signals from the detector 136 to determine a gas concentration measurement of the target gas within the sample chamber 120. In some embodiments, the controller 140 may be external to the sensor 102. The controller 140 may be coupled to the source 114, detector 136, or both, with wired communication, wireless communication or combinations thereof. In some embodiments, the sensor 102 may be coupled using commercially available connection standards (e.g., Bluetooth, Wi-Fi, and/or USB). In some embodiments, the controller 106 may be a purpose built piece of equipment, a general purpose computer (e.g., a tablet, a laptop, a desktop, a phone), a microcontroller, or combinations thereof.

In an example implementation, the signals from the source 114 and detector 136 are provided to the controller 140. An analog-to-digital converter (ADC) 142 of the controller 140 receives the signals from the sensor 102 and generates digital signals based on the received signals. The digital signals are provided to a communications module 146 and to a system logic circuit 144.

The system logic 144 may process the raw signals and generate one or more outputs based on those signals. The system logic 144 may be a microprocessor, a FPGA, a custom chip, or combinations thereof. The system logic 144 generates a gas concentration measurement of a target gas within the sample chamber 120. For example, the system logic 144 may use one or more of Eqns. 5-8 to determine the concentration based on a signal from the detector 136. The signal from the detector 136 may represent the measured output light intensity Iₒᵤₜ. In some embodiments, the other variables of the equation may be pre-programmed into the system logic 144. In some embodiments, various other factors may be used to determine the concentration. For example, the system logic 144 may set a level of the source by sending a signal to the source 114. This in turn may determine the value of I₀.

In some embodiments, the system logic 144 may take into account additional measurements (e.g., temperature, pressure and/or humidity), for example to more accurately determine the coefficient of extinction ρσ for the given conditions. For example, one or more additional sensors may be located on the sensor 102, such as a temperature sensor, a pressure sensor, a humidity sensor, or combinations thereof. These additional sensors may provide measurement data of the additional measurements to the controller 140.

The communications module 146 may send and receive information to and from the controller 140. For example, the communications module 146 may be a wireless and/or wired connection to an outside system. In some embodiments, the communications module 146 may provide a calculated gas concentration measurement from the system logic 144. In some embodiments the communications module 146 may send one or more raw measurements (e.g., the measured value from the detector 136) instead of or in addition to the calculated concentration. In some embodiments, the communications module 146 may receive instructions (e.g., an ‘on’ command, a command to take a measurement, etc.) from an external source.

The controller 140 has been shown in FIG. 1 as an external component. However, in some embodiments of the present disclosure, one or more components of the controller 140 may be integrated into the sensor. For example, one or more components may be located on circuit boards which are attached to the source 114 and/or detector 136

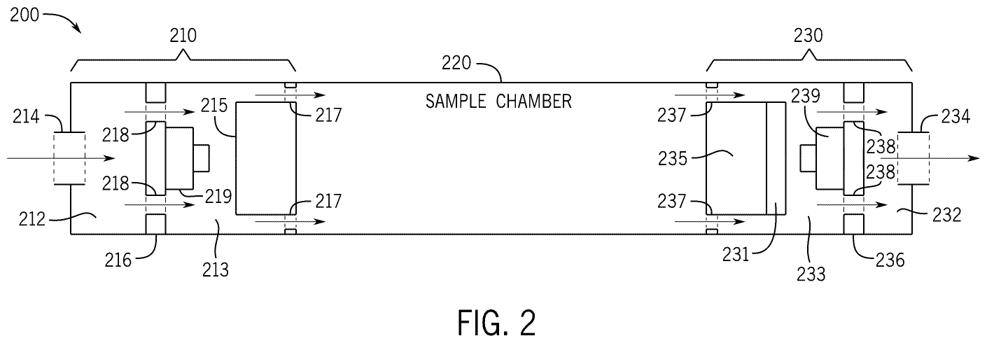

FIG. 2 is a cross-sectional diagram of a flow-through gas sensor with cavity enhancement according to some embodiments of the present disclosure. The sensor 200 of FIG. 2 may, in some embodiments, implement the sensor 102 of FIG. 2. The sensor 200 represents an embodiment where sample gas flows through the sensor 200 and into the sample chamber 220 and then out of sample chamber 220 and out of the sensor 200. An example flow of sample gas through the sensor 200 is represented by the arrows in FIG. 2.

The sensor 200 includes an illumination carrier 210 (which includes illumination optics such as 110 of FIG. 1), a sample chamber 220 (e.g., 120 of FIG. 1), and a detector carrier 230 (which includes detector optics such as 130 of FIG. 1). The illumination carrier 210 includes an illumination substrate 216 (e.g., a circuit board) which holds an illumination source 219 (e.g., 114 of FIG. 1). The detector carrier 230 includes a lens 231 (e.g., 134 of FIG. 1), and a detector substrate 236 (e.g., a circuit board) which supports a detector 239. The sensor 200 also includes a reflector 215 (e.g., reflector 112 of FIG. 1) and a reflector 235 (e.g., reflector 132 of FIG. 1). The two reflectors 215 and 235 may be housed in their own carriers in some embodiments, which are attached between the illumination carrier 210 and sample chamber 220 and between the sample chamber 220 and detector carrier 230 respectively. In some embodiments, the two reflectors 215 and 235 may be housed in the two carriers 210 and 230. In some embodiments, the two reflectors may be housed in their own carriers, which in turn form part of the larger illumination carrier and detector carrier respectively.

The sensor 200 includes a first port 214 and a second port 234 either or both of which allow allows the target gas to enter the sample chamber 220. The illumination carrier 210 includes a first port 214 fluidly coupled between an outside of the sensor 200. The illumination carrier 210 also includes a first manifold 212 and a second manifold 213. The first manifold is on a first side of the substrate 216 and the second manifold is on the opposite side of substrate 213. Using the convention that the side closer to the sample chamber 220 is the front and the opposite side is the back, then the first manifold 212 is on a back side of the substrate 216 and the second manifold 213 is on a front side of the substrate 216. One or more passages 218 (e.g., flow apertures) through the substrate 216 fluidly couple the first manifold 212 the second manifold 213. One or more passages 217 (e.g., flow apertures) coupled the second manifold 213 to the sample chamber 217 past the reflector 215. In a similar fashion, the sample chamber 220 is fluidly coupled through one or more passages 237 past the second reflector 235 and lens 231 into a third manifold 233 in the detector carrier 230. The detector carrier 230 also includes a fourth manifold 232. The third manifold 233 is fluidly coupled to the fourth manifold 232 through one or more passages 238 in the detector substrate. The fourth manifold 232 is fluidly coupled outside the sensor 200 via a second port 234. The third manifold 233 is positioned on a front side of the substrate 236, while the fourth manifold 232 is positioned on a back side of the substrate 236.

In some embodiments, the gas sample may enter and exhaust through the ports 214 and 234 to an ambient environment around the sensor 200. In some embodiments, the gas sample may enter one of the ports 214 and 234 from a controlled source (e.g., a suspected leak site, a container with a sample, etc.). In some embodiments, the gas sample may be exhausted into a container and/or filter. In some embodiments, the sensor 200 may be position ‘in-line’ with a pipe or tube that the gas was flowing through.

In the example illustration of FIG. 2, the first port 214 is shown as an inlet and the second port 234 is an outlet. Arrows illustrate an example flow of gas (or other component to be detected) from the inlet 214 through the illumination substrate 216, past the reflector 217, into the sample chamber 236, through the detection substrate 236 and out the outlet 234. However, in some embodiments, the direction of flow may be reversed, with the gas sample flowing from the second port 234 into the sample chamber 220 and out the first port 214 (e.g., the second port 234 may be the inlet and the first port 214 may be the outlet). In some embodiments, a single sensor 200 may operate with gas flowing in either direction. For the sake of consistency, the example sensors and components described herein will generally be described with respect to a gas sample flowing into an illumination carrier through a sample chamber and out the detection carrier. However, any of the sensors described herein may be set up to operate in either direction.

The carriers 210 and 230 include a respective substrates 216 and 236. The substrates, may in some embodiments, be implemented as circuit boards. The circuit boards 216 and 236 include one or more electronic components that enable the operation of the respective illumination source 219 and detector 239 or may otherwise be used to communicate therebetween. For example, the circuit boards 216 and 236 may include driver circuits (e.g., current and/or voltage drivers), switches, sensors, conductive elements (e.g., buses, wires, etc.), control logic, power sources, interface terminals (e.g., external connections), or combinations thereof.

The circuit boards 216 and 236 may generally be flat, with a first side and a second side opposite the first side act as a substrate or support structure to receive one more electronic components. The circuit boards 216 and 236 may have any geometry, such as circular, square, rectangular, etc. One side of the circuit boards 216/236 may generally be positioned facing the sample chamber 220, while a second side is positioned facing away from the sample chamber 220. Each carrier 210 and 230 includes a respective pair of manifolds 212 and 213 or 232 and 233 on either side of the circuit boards. The circuit boards 216 and 236 include one or more passages 218 and 238 (e.g., apertures or through holes) respectively that pierce or extend through a thickness of the circuit board 216/236 to place the front and the back side of the circuit board in fluid communication with each other such that gases and other fluids can pass from one side of the circuit board to the other. The passages 218 and 238 may be formed in the material of the circuit board 216/236 or may be added by later processing (e.g., drilled through the board).

In some embodiments, one or both of the circuit boards 216 and 236 may include one or more additional sensors. For example, temperature sensors, pressure sensors, humidity sensors, or combinations thereof may be positioned on one or both of the circuit boards 216 and 236. In some embodiments, the illumination circuit board 216 provides a signal which indicates a power output of the illumination source 219. In some embodiments, the illumination circuit board 216 may receive a signal which controls the power of the illumination source 219.

The two carriers 210 and 230 each include a respective reflector 215 and 235. The reflector 215/235 are positioned between sample chamber 220 and the front manifold 213 or 233 of the respective carrier 210/230. The passage 217 couples the manifold 213 with an interior of the sample chamber 220 around the reflector 217. The passages 237 couple the interior of the sample chamber 220 to the manifold 233 around the reflector 235 and lens 231. The passages 217 and 237 may be formed in the material of the illumination carrier 210 and detector carrier 230.

The sample chamber 220 contains and/or is able to receive a gas sample and allows light to pass from the illumination source 219 to the detector 239. It may be advantageous for the sample chamber 220 to maximize the amount of light which can pass from the source 219 to the detector 239. In some example embodiments, the sample chamber 220 may be a tube or pipe (e.g., include a flow passage therethrough). In some embodiments the sample chamber 220 may have continuous side walls. In some embodiments, the sample chamber 220 may include holes in the side walls which allow sample gas to enter and/or exit through passages 217 and 237. The ends of the sample chamber 220 may be formed by the front surfaces of the reflector 215 and 235. In some embodiments, the reflectors 215 and/or 235 may be implemented by mirrors. In some embodiments, a lumen defined within the sample chamber 220 may be reflective or otherwise have a high albedo. For example, the lumen of the sample chamber 220 may have a reflective coating, such as being gilded.

In some embodiments, the ports 214 and/or 234 may be open or fluidly coupled to an ambient environment. In some embodiments, the sensor 200 may be positioned near a target area (e.g., a wellsite, a piece of industrial equipment, a landfill, etc.) to monitor for the presence of the target gas in that area. In some embodiments, the gas sample (or fluid including such a sample) may be flowed into or otherwise directed into the sample chamber 220. For example, an optional pump (not shown) may apply pressure to move the gas sample into the sample chamber 220. The pump may draw the sample gas from the ambient environment or may be coupled to a source of the sample gas. For example, a piece of equipment to be monitored may be surrounded in a gas impermeable layer (e.g., plastic sheeting) and the air inside the layer may be moved by the pump into the sample chamber.

In some embodiments, the sensor 200 may include additional hardware not shown in the view of FIG. 2. For example, the sensor 200 may include O-rings, gaskets, sealant or other hardware to prevent inadvertent flow gas through the sensor 200 (e.g., configured to generate a seal). In some embodiments, fasteners (e.g., screws, bolts etc.) not shown in FIG. 2 may be used to hold the sensor 200 together. In some embodiments, the sensor 200 may include housing or other enclosure. In some embodiments 200 the sensor may include one or more access or communications ports, such as power and/or data ports which connect to an external controller (e.g., 140 of FIG. 1).

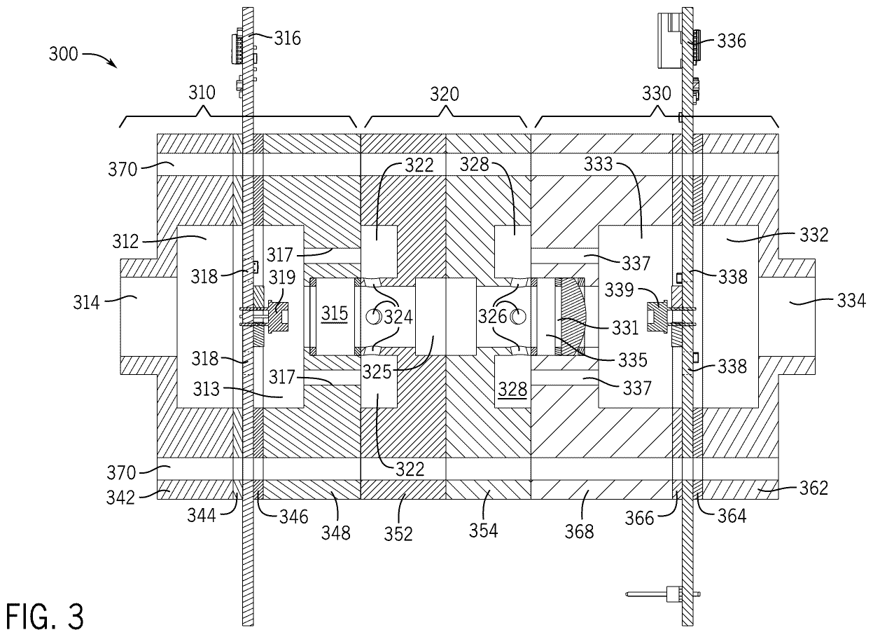

FIG. 3 is a cross-sectional schematic of an example flow-through gas sensor with cavity enhancement according to some embodiments of the present disclosure. The sensor 300 may, in some embodiments, implement the sensor 102 of FIG. 1 and/or the sensor 200 of FIG. 2. In particular, the sensor 300 represents an example implementation of a flow-through or in-line cavity enhanced gas sensor such similar to the sensor 200 of FIG. 2.

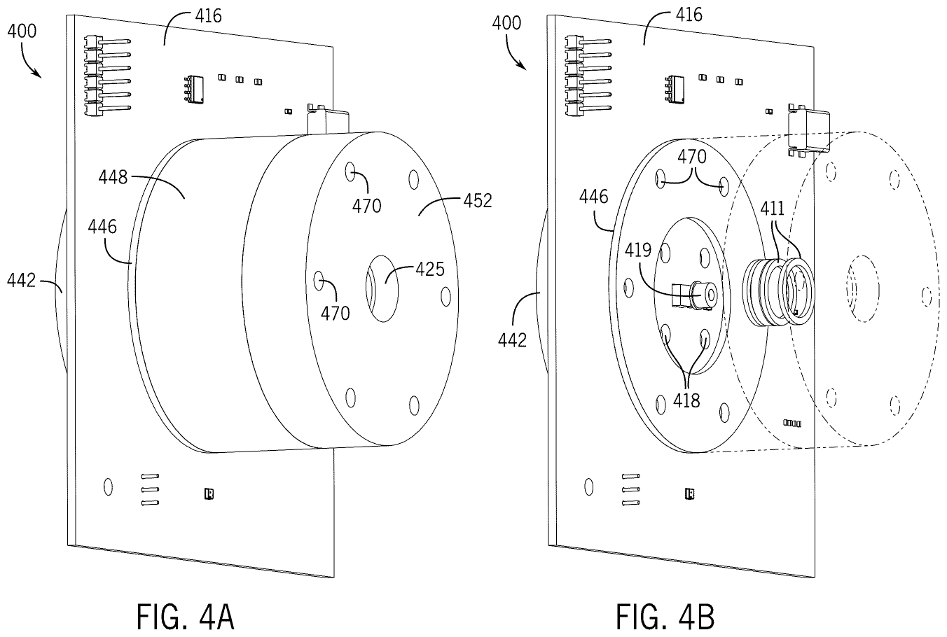

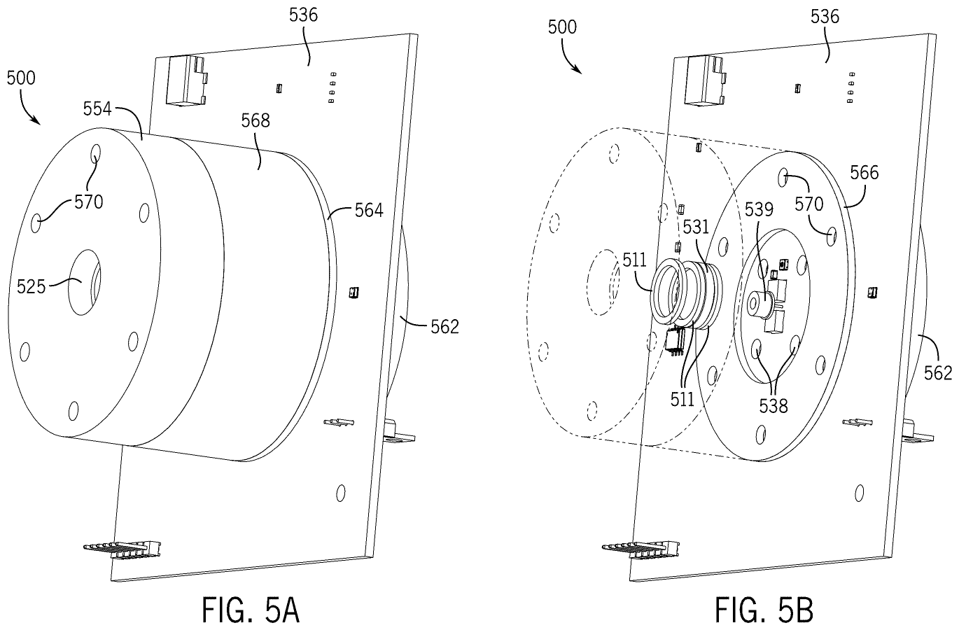

The sensor 300 includes an illumination carrier 310 (e.g., 210 of FIG. 2) which includes illumination optics (e.g., 110 of FIG. 1) such as an illumination source 319 (e.g., 114 of FIG. 1 and/or 219 of FIG. 2) and a mirror 315 (e.g., 112 of FIG. 1 and/or 215 of FIG. 2). The illumination carrier 310 supports a first reflector carrier 348 which holds the first reflector 315. The sensor 300 also includes a detector carrier 330 (e.g., 230 of FIG. 3) which includes detection optics (e.g., 130 of FIG. 1) such as a detector 339 (e.g., 136 of FIG. 1 and/or 239 of FIG. 2), a mirror 335 (e.g., 132 of FIG. 1 and/or 235 of FIG. 2), and a lens 331 (e.g., 134 of FIG. 1 and/or 231 of FIG. 2). The detector carrier 330 supports a second reflector carrier 368 which holds the second reflector 335 and the lens 331. The sensor 300 also includes a sample chamber assembly 320 which includes a sample chamber 325 (e.g., 120 of FIG. 1 and/or 220 of FIG. 2). FIG. 3 (and FIGS. 4A-5B) are generally described with respect to an example implementation where mirrors are used as the reflectors, however other reflector types may be used in other example embodiments.

The illumination carrier 310 includes an inlet 314 (e.g., 214 of FIG. 2), a first manifold 312 (e.g., 212 of FIG. 2), an illumination circuit board 316 (e.g., 216 of FIG. 2) which supports the illumination source 319, a second manifold 313 (e.g., 213 of FIG. 2), and the mirror 315. The first manifold 312 is on a back side of an illumination circuit board 316, and the second manifold 313 is on a front side of the illumination circuit board 316. The two manifolds 312 and 313 are fluidly coupled through passages 318 which penetrate a thickness of the circuit board 316. Passages 317 fluidly couple the second manifold 313 into the sample chamber assembly 320.

The illumination carrier 310 may be formed from a first component 342 and a second component 348. The two components sandwich and hold the illumination circuit board 316. seals 344 and 346 are used to form a seal between the components 342 and 348 and the circuit board 316. The seals 344 and 346 may be o-rings, gaskets, lip seals, u cups, sealants, or any combinations thereof. The first component 342 includes the inlet 314 and a chamber which acts as the first manifold 312. The opening of the first manifold 312 is positioned next to the back side of the circuit board 316 with seal 344 in between the first component 342 and the circuit board 316. The second component 348 includes a chamber which acts as the second manifold 313, the passages 317, and a receptacle which holds the mirror 315. The second component 348 may be considered as the first reflector carrier. The opening of the second manifold 313 is positioned next to the front side of the circuit board 316 with seal 346 in between. The mirror 315 is held in its receptacle by seals. The mirror is positioned in an opening between the second manifold 313 and the front end of the illumination carrier 310. The mirror 315 and its chamber may be sealed to prevent the passage of gas through the chamber which holds the mirror. The mirror 315 is aligned with the illumination source 319 to allow the passage of light through the mirror. The passages 317 may be tubes or other holes formed in the material of the second component 348 to allow gas to flow from the manifold 313 to openings in the front of the second component 348.

The sample chamber assembly 320 includes a sample chamber 325, which has openings on either end of the assembly 320 which are aligned with the mirror 315 in the illumination carrier 310 and the mirror 335 in the detector carrier 330. The sample chamber may thus form an optical cavity between the two mirrors 315 and 335. The sample chamber assembly 320 is formed from a first sample assembly component 352 and a second sample assembly component 354. The first sample assembly component 352 includes one or more chambers. The chamber(s) 322 have openings which align with the openings of the passages 317 in the second illumination carrier component 348. In this manner, the chamber(s) 322 are in fluid communication with the second manifold 313 through the passages 317. The chamber(s) 322 are coupled through passages 324 to the sample chamber 325. In the example implementation of FIG. 3, the chamber(s) 322 surround the sample chamber, and the passages 324 couple from a side wall of the chamber(s) 322 to a side wall of the sample chamber 325. In this manner, the chamber(s) 322 are in fluid communication with an interior of the sample chamber 325. The first component 352 has an opening of the sample chamber 325 which matches an opening in the second sample assembly component 354.

The second sample assembly component 354 may be generally similar to the first sample assembly component 352. The second sample assembly component 354 includes one or more passages 326 which fluidly couple the sample chamber 325 to one or more chambers 328. The chamber(s) 328 have openings on a back side of the component 354 which are in fluid communication with passages 337 in the detector carrier 330. In some example implementations, the two components 352 and 354 may be structurally identical to each other, and the sample chamber assembly 320 may be formed by mating matching sides of the two components 352 and 354.

The detector carrier 320 includes an outlet 334 (e.g., 214 of FIG. 2), a third manifold 333 (e.g., 233 of FIG. 2), a detector circuit board 336 (e.g., 236 of FIG. 2) which supports the detector 339, a fourth manifold 332 (e.g., 232 of FIG. 2), and the mirror 315 and lens 331. The fourth manifold 332 is on a back side of the detector circuit board 336, and the third manifold 333 is on a front side of the detector circuit board 336. The two manifolds 332 and 333 are fluidly coupled through passages 338 which penetrate a thickness of the circuit board 336. Passages 337 fluidly couple the third manifold 333 into the sample chamber assembly 320. The passages 337 may couple to the chamber(s) 328 of the second sample assembly component 354.

The detector carrier 330 may be formed from a first detector carrier component 362 and a second detector carrier component 368. The two components 362 and 368 sandwich and hold the detector circuit board 336. Seals 364 and 366 are used to form a seal between the components 362 and 368 and the circuit board 336. The first component 362 includes the inlet 334 and a chamber which acts as the first manifold 332. The opening of the first manifold 332 is positioned next to the back side of the circuit board 336 with Seals 364 in between the first component 362 and the circuit board 336. The second component 368 includes a chamber which acts as the second manifold 333, the passages 337, and a receptacle which holds the mirror 315 and lens 331. The second component 368 may be considered as a second reflector carrier. The opening of the second manifold 333 is positioned next to the front side of the circuit board 336 with Seals 366 in between. The mirror 315 and lens 331 are held in their receptacle by seals with a spacer in between the mirror 335 and lens 331. The lens 331 may be a plano-convex lens with the convex side facing the manifold 333. The mirror 335 and lens 331 are positioned in an opening between the third manifold 333 and the front end of the detector carrier 330. The mirror 335 and lens 331 are sealed in their chamber in the component 368 to prevent the passage of gas through the chamber which holds the mirror 335 and lens 331. The mirror 335 and lens 331 are aligned with the detector 339 to allow the passage of light through the mirror 335 and lens 331 from the sample chamber 325 to the detector 339. The passages 337 may be tubes or other holes formed in the material of the second component 368 to allow gas to flow from the manifold 333 to openings in the front of the second component 368. When the sensor is assembled, those openings match the openings of the chamber(s) 328.

The components 342-368 may be set up such that when assembled the illumination source 319, mirror 315, mirror 335, lens 331 and detector 339 are aligned. For example, those components may share a common optical axis with each other. The optical axis may be aligned down a center of the sample chamber 325. In an example implementation, the components 342-368 may include one or more bolt holes 370. Each component 342-368 may have a bolt hole which penetrates the thickness of the component. When the components of the sensor 300 are assembled the bolt holes may align so that bolts (and/or other fasteners) may be run down the length of the sensor 300, coupling the components together. Other ways of assembling the sensor 300 may be used in other example embodiments.

In some example implementations, the assembled sensor 300 may be general tubular and the components 342-368 may have generally radial symmetry. In some example implementations, the circuit boards 316 and 336 may extend beyond the outer edge of the other components of the sensor 300. In some embodiments, the circuit boards 316 and 336 may be generally square or rectangular. Other geometries may be used in other example implementations.

FIGS. 4A and 4B are perspective views of an illumination carrier and portion of a sample chamber according to some embodiments of the present disclosure. FIGS. 4A and 4B show a perspective view of a portion 400 of a sensor, which may, in some embodiments, implement a portion of the sensor 102 FIG. 1, 200 of FIG. 2, and/or 300 of FIG. 3. In particular, the portion 400 shows an illumination carrier (e.g., 210 of FIG. 2 and/or 310 of FIG. 3) and a portion of the sample chamber. For example, the portion 400 shows a first component of an illumination carrier 442 (e.g., 342 of FIG. 3), an illumination circuit board 400, a seal 446 (e.g., 346 of FIG. 3), a second component of the illumination carrier 448, and a first portion of a sample chamber assembly 452 (e.g., 352 of FIG. 3). The views of FIGS. 4A and 4B may generally be the same except that in the view of FIG. 4B, the components 448 and 452 have been made transparent.

In some embodiments, the components 442, 446, 448, and 458 are generally cylindrical. In some embodiments, the components 442, 446, 448, and 458 may generally have a same external diameter. In some embodiments, the circuit board 416 is generally square and extends beyond the edges of the other components. Other geometries may be used in other example embodiments. Bolt holes 470 are positioned towards the edge of the components as may be seen in the face of the components 452 in FIG. 4A and 446 of FIG. 4B. FIG. 4A shows the opening of the sample chamber 425. When assembled, the face of the component 452 would be in contact with the face of matching component to enclose the sample chamber.

The view of FIG. 4B allows the illumination source 419 to be seen, along with passages 418 through the circuit board 416. Also shown are seals 411 which hold the mirror (not shown in FIG. 4B) in place within the component 448.

FIGS. 5A and 5B are perspective views of a detector carrier and portion of a sample chamber according to some embodiments of the present disclosure. FIGS. 5A and 5B show a perspective view of a portion 500 of a sensor, which may, in some embodiments, implement a portion of the sensor 102 FIG. 1, 200 of FIG. 2, and/or 300 of FIG. 3. In particular, the portion 500 shows a detector carrier (e.g., 230 of FIG. 2 and/or 330 of FIG. 3) and a portion of the sample chamber. For example, the portion 500 shows a first component of an detector carrier 562 (e.g., 362 of FIG. 3), an detector circuit board 536 (e.g., 336 of FIG. 3), an seal 566 (e.g., 366 of FIG. 3), a second component of the detector carrier 568, and a first portion of a sample chamber assembly 554 (e.g., 354 of FIG. 3). The views of FIGS. 5A and 5B may generally be the same except that in the view of FIG. 5B, the components 568 and 554 have been made transparent.

In some example embodiments, the components 562, 564, 568, and 554 are generally cylindrical. In some embodiments, the components 562, 564, 568, and 554 may generally have a same external diameter. In some embodiments, the circuit board 536 is generally square and extends beyond the edges of the other components. Other geometries may be used in other example embodiments. Bolt holes 570 are positioned towards the edge of the components as may be seen in the face of the components 554 in FIG. 5A and 566 of FIG. 5B. FIG. 5A shows the opening of the sample chamber 525. When assembled, the face of the component 554 would be in contact with the face of matching component to enclose the sample chamber. For example, the face of component 554 would match to the face of component 452 of FIG. 4A.

The view of FIG. 4B allows the detector 539 to be seen, along with passages 538 through the circuit board 536. Also shown are seals 511 which hold the mirror (not shown in FIG. 4B) and lens 531 in place within the component 568. In FIG. 5B, there are three seals 511 with one seal positioned between the mirror and lens 531 and the other two seals on the front surface of the mirror and the back surface of the lens 531.

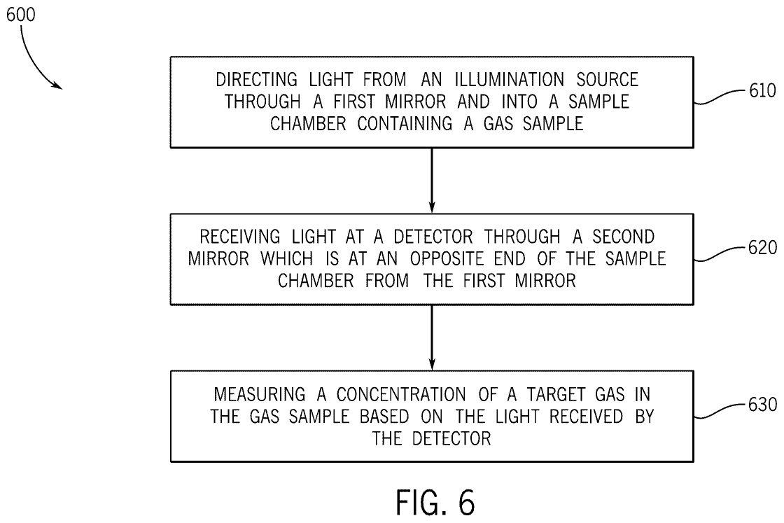

FIG. 6 is a flow chart of a method of operating a cavity enhanced gas sensor according to some embodiments of the present disclosure. The method 600 may, in some embodiments, be performed by one or more of the apparatuses and/or systems described herein. For example, the method 600 may represent an operation of the measurement system 100 of FIG. 1, the sensor 200 of FIG. 2, and/or the sensor 300 of FIG. 3.

The method 600 may generally begin with block 610 which describes directing light from an illumination source (e.g., 114 of FIG. 1, 219 of FIG. 2, 319 of FIG. 3, and/or 419 of FIG. 4B) through a first reflector, or mirror, (e.g., 112 of FIG. 1, 215 of FIG. 2, and/or 315 of FIG. 3) and into a sample chamber (e.g., 120 of FIG. 1, 220 of FIG. 2, 325 of FIG. 3, 425 of FIGS. 4A-B, and/or 525 of FIGS. 5A-5B) containing a gas sample.

Block 610 may generally be followed by block 620 which describes receiving light at a detector (e.g., 136 of FIG. 1, 239 of FIG. 2, 339 of FIG. 3, and/or 539 of FIG. 5B) through a second reflector, or mirror, (e.g., 132 of FIG. 1, 235 of FIG. 2, and/or 335 of FIG. 3) which is at an opposite end of the sample chamber from the first reflector. In some embodiments, the method 600 may including receiving light at least a portion of which has been reflected between the first reflector and the second reflector at least once. In some embodiments, the method 600 may include focusing the light which exits the second reflector through a lens (e.g., 134 of FIG. 1, 231 of FIG. 2, 331 of FIG. 3, and/or 531 of FIG. 5B) onto the detector.

Block 620 may generally be followed by block 630, which describes measuring a concentration of a target gas in the gas sample based on the light received by the detector. For example, a controller (e.g., 140 of FIG. 1) may use one or more of Eqns. 5-8 to determine the concentration based on a measurement of the intensity of the received light. In some embodiments, the method may include measuring additional properties of the gas sample with one or more sensors. The additional properties may include temperature, pressure, humidity, or combinations thereof. The method may include determining the gas concentration based, in part, on the additional properties. In an example application, the method 600 may include collecting the gas sample from a suspected emission source and determining if the suspected emission source is emitting the target gas based on the measured concentration. In some embodiments, the target gas may be methane.

In some embodiments, the method may include receiving the gas sample through a first port and into a first manifold and passing the gas sample through a circuit board which supports the illumination source to a second manifold. The method may also include passing the gas sample from the second manifold into an interior of the sample chamber and from the sample chamber into a third manifold. The method may also include passing the gas sample from the third manifold through a second circuit board which supports the detector to a fourth manifold and exhausting the gas sample through a second port from the fourth manifold.

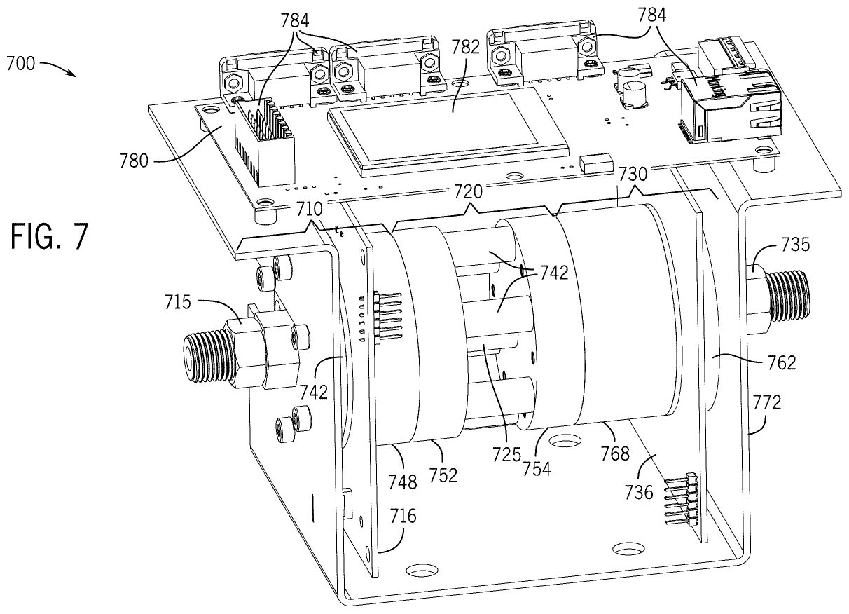

FIG. 7 is a perspective view of an in-line sensor according to some embodiments of the present disclosure. The sensor 700 may, in some embodiments, implement the sensor 102 of FIG. 1 and/or 200 of FIG. 2. The sensor 700 may, in some embodiments, perform the method 600 of FIG. 6. The sensor 700 may represent an alternate implementation compared to the sensor 300 of FIG. 3. While representing a different implementation, the sensor 700 may be broadly similar to the senor 300 of FIG. 3. For the sake of brevity, certain details already described with respect to FIG. 3-5 will not be repeated again with respect to FIG. 7.

The sensor 700 includes an illumination carrier 710 (e.g., 210 of FIG. 2), which includes illumination optics (e.g., 110 of FIG. 1) such as an illumination source. The illumination carrier 710 supports a first reflector carrier 748, which holds a first reflector. The sensor 700 also includes a detector carrier 730 (e.g., 230 of FIG. 2) which includes detector optics (e.g., 130 of FIG. 1) such as a detector. The detector carrier 730 supports a second reflector carrier 768, which supports a second reflector. The sensor 700 also includes a sample chamber assembly 720, which includes a sample chamber 725 (e.g., 120 of FIG. 1 and/or 220 of FIG. 2).

The sensor 700 includes an optional frame 772, which supports the illumination carrier 710 and the detector carrier 730. For example, the frame 772 may be bolted to a back component 742 of the illumination carrier 710 and to a back component 762 of the detector carrier 730. The sensor 700 has optional supports 774 which couple the illumination carrier 710 and detector carrier 730 together. In the example of FIG. 7, the supports 774 may be arranged around the sample chamber 725. For example, the sample chamber assembly 720 includes a first component 752 and a second component 754. The first component 752 is coupled to the first reflector carrier 748 and the second component 754 is coupled to the second reflector carrier 768. For example the components 752 and 754 may be coupled via bolts or screws. The first component 752 is coupled to a first end of the supports 774 and the second component 754 is coupled to a second end of the supports 774. The supports 774 may be rods or tubes. In some embodiments, the supports 774 may internally include bolts or screws to help couple the components 752 and 754 together.

The sensor 700 includes fittings 715 and 735. The fittings 715 and 735 may be used to couple the sensor 700 to pipes carrying the sample gas. The fittings 715 and 735 may be standard pipe fittings which couple to an input pipe and an output pipe for the sample gas. In this manner, the sensor 700 may be installed ‘in-line’ with a pipe carrying the sample gas.

In the embodiment of FIG. 7, the frame 772 supports an optional interface circuit board 780. The interface board 780 includes a display 782 and one or more connection ports 784. The display may, in some embodiments, be a touch screen and allow for both input and output. In some embodiments, the interface board 780 may implement all or a part of the controller 140 of FIG. 1. In some embodiments, the interface board 780 may be coupled (e.g., via the ports 784) to one or more external systems, which may implement all or part of the controller 140.

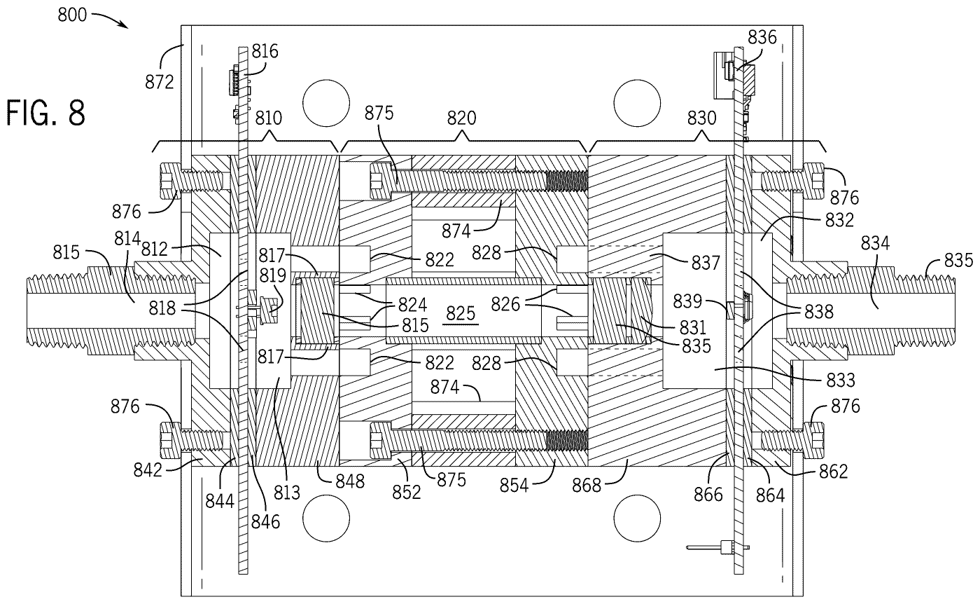

FIG. 8 is a cross-sectional schematic of an example flow-through gas sensor with cavity enhancement according to some embodiments of the present disclosure. The sensor 800 may, in some embodiments, implement the sensor 102 of FIG. 1 and/or 200 of FIG. 2. The sensor 800 may, in some embodiments, perform the method 600 of FIG. 6. The sensor 800 may represent an alternate implementation compared to the sensor 300 of FIG. 3. While representing a different example implementation, the sensor 700 may be broadly similar to the senor 300 of FIG. 3. The sensor 800 may represent a cross-sectional view of the sensor 700 of FIG. 7. For the sake of brevity, certain details already described with respect to FIGS. 3-5 and 7 will not be repeated again with respect to FIG. 8.

The sensor 800 includes an illumination carrier 810 (e.g., 210 of FIG. 2 and/or 710 of FIG. 7) which supports illumination optics (e.g., 110 of FIG. 1) such as an illumination source 819 (e.g., 114 of FIG. 1, and/or 219 of FIG. 2). The illumination carrier 810 includes a first reflector carrier 848 (e.g., 748 of FIG. 7) which holds a first reflector 815 (e.g., 112 of FIG. 1 and/or 215 of FIG. 2). The sensor also includes a detector carrier 830 (e.g., 230 of FIG. 3 and/or 730 of FIG. 7) which supports detector options (e.g., 130 of FIG. 1) such as a detector 839. The detector carrier 830 includes a second reflector carrier 868 (e.g., 768 of FIG. 7) which supports a second reflector 835 (e.g., 132 of FIG. 1 and/or 235 of FIG. 2) and a lens 831 (e.g., 134 of FIG. 1 and/or 231 of FIG. 2).

Similar to the embodiment of FIGS. 3-5B, the sensor 800 includes a first manifold 812, which is fluidly coupled to a second manifold 813 through passages 818 in an illumination circuit board 816, and a third manifold 833 and fourth manifold 832 coupled together through passages 838 in the detector circuit board 836. Similarly, the illumination carrier 810 is formed from a first component 842, a first seal 844, the illumination circuit board 816, a second seal 846, and a second component 848 (or first reflector carrier). The detector carrier 820 is formed from a first component 862, a first seal 864, the detector circuit board 836, a second seal 866, and a second component 868 (or second reflector carrier). These components may be generally analogous to the corresponding components of FIGS. 3-5B, although they differ in geometry.

In the sensor 800, the sample assembly 820 is formed from a first component 852, a second component 854, a sample chamber 825 and one or more supports 874. The first sample assembly component 852 includes one or more chambers 822 which surround an outside of the sample chamber 825. The sample chamber 825 may be generally tubular, with ends formed by the front surfaces of the reflectors 815 and 835. Passages 824 in the walls of the sample chamber 825 couple the lumen of the sample chamber 825 to the one or more chambers 822. The one or more chambers 822 are fluidly coupled through passages 817 (e.g., 217 of FIG. 2) to the second manifold 813. Similarly, the second sample assembly component 854 includes one or more chambers 828 which surround an outside of the sample chamber 825. Passages 826 couple the one or more chambers 828 to the lumen of the sample chamber 825. The one or more chambers 838 are fluidly coupled through passages 837 (e.g., 237 of FIG. 2) to the third manifold 833.

The sample chamber 825 may be formed by a pipe or tube and may be fitted into corresponding openings in the components 852 and 854 in some embodiments. In some embodiments, the chamber 825 may be integral to the two components 852 and 854. In some embodiments, a support, such as a sleeve, may be placed around an outer perimeter of the sample chamber 825. In the embodiment of FIGS. 7-8, there is a gap between a front face of the component 852 and a front face of the component 854. The sample chamber 825 may extend across this gap. In some embodiments, the sample chamber 825 may have a smaller diameter than the diameters of the components 852 and 854. The two components 852 and 854 may be held together by one or more supports 874. In the embodiment of FIGS. 7-8, the supports 874 are formed from a tube with a fastener 875 such as a bolt or screw running down the middle. The fastener 875 couples to the two components 852 and 854. For example, the component 852 may be held by a head of the fastener, while the component 854 may be threaded to the fastener 875.

The components of the illumination carrier 842-848 are couple together by fasteners, not shown in FIG. 8. Those same fasteners couple the illumination carrier 810 to the first component 852 of the illumination assembly 820. Similarly, the components 862-868 of the detector carrier are coupled together by fasteners (not shown). Those same fasteners couple the detector assembly 830 to the second component 854 of the detector assembly 820. In embodiments where the optional frame 872 (e.g., 772 of FIG. 7) is used, the frame 872 is coupled to the first illumination component 844 by fasteners 876 and coupled to the first detector component 862 by fasteners 876.

The first illumination carrier component 842 includes an inlet 814. The inlet 814 is coupled to a first fitting 815. The first detector carrier component 862 includes an outlet 834. The outlet is coupled to a second fitting 835. The fittings 815 and 835 may be chosen based on the application to mate with different connections to provide and exhaust the sample gas respectively. For example, the fittings 815 and 835 may be modular components which are installed into the inlet 814 and outlet 834 based on the chosen application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Terms like ‘light’ and ‘optical’ are used herein to refer to electromagnetic energy, and should not be taken as limiting the wavelengths of the electromagnetic spectrum that the present disclosure may relate to. Different applications may use different wavelengths other than those described herein, which may in turn, indicate different technologies for the illumination source and/or detector. Similarly, filters, reflectors, and other materials may generally be described with respect to an example application and its associated wavelengths and is not intended to be limiting. For example, while gold is discussed as an example reflective material herein, other reflective materials may be used in other example embodiments where other wavelengths are used.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a first reflector;
a second reflector;
a sample chamber positioned between the first reflector and the second reflector, wherein the sample chamber is configured to hold a sample gas;
an illumination source configured to direct light through the first reflector and into the sample chamber; and
a detector configured to receive light from the sample chamber through the second reflector, wherein at least a portion of the received light has reflected through the sample chamber between the first and the second reflector one or more times.

2. The apparatus of claim 1, wherein the first reflector has a higher reflectivity than the second reflector.

3. The apparatus of claim 1, wherein the first reflector has a first side facing the illumination source and a second side facing the sample chamber, wherein the first side has an anti-reflective coating and the second side has a highly reflective coating.

4. The apparatus of claim 1, further comprising a lens positioned between the second reflector and the detector.

5. The apparatus of claim 1, further comprising:
an illumination circuit board having a first side and a second side, wherein the illumination circuit board is configured to hold the illumination source on the second side;
a first manifold positioned on the first side of the illumination circuit board; and
a second manifold positioned on the second side of the illumination circuit board,
wherein at least one passage through the illumination circuit board fluidly couples the first manifold to the second manifold and wherein the second manifold is fluidly coupled to an interior of the sample chamber.

6. The apparatus of claim 1, further comprising:
a detector circuit board having a first side and a second side, wherein the detector circuit board is configured to hold the detector on the first side;
a first manifold positioned on the first side of the detector circuit board; and
a second manifold positioned on the second side of the detector circuit board,
wherein at least one passage through the detector circuit board fluidly couples the first manifold and the second manifold, and wherein the first manifold is fluidly coupled to an interior of the sample chamber.

7. The apparatus of claim 1, further comprising a controller configured to measure a concentration of a target gas in the gas sample based on the received light at the detector.

8. The apparatus of claim 7, wherein the target gas is methane.

9. The apparatus of claim 1, wherein the apparatus is a non-dispersive infrared sensor.

10. An apparatus comprising:
a sample chamber;
an illumination carrier comprising:
a first manifold;
a second manifold;
a first substrate configured to hold an illumination source, the first substrate comprising passages configured to fluidly couple the first manifold to the second manifold; and
a first reflector positioned between the second manifold and the sample chamber, wherein passages in the illumination carrier fluidly couple the second manifold to an interior of the sample chamber; and
a detector carrier comprising:
a third manifold;
a fourth manifold;
a second substrate configured to hold a detector, the second substrate comprising passages configured to fluidly couple the third manifold to the fourth manifold; and
a second reflector positioned between the third manifold and the sample chamber, wherein passages in the detector carrier fluidly couple the third manifold to the interior of the sample chamber.

11. The apparatus of claim 10, further comprising:
a first port fluidly coupled to the first manifold; and
a second port fluidly coupled to the second manifold.

12. The apparatus of claim 10, wherein the detector carrier further comprises a lens positioned between the second reflector and the detector.

13. The apparatus of claim 10, wherein the first reflector and the second reflector form an optical cavity along the sample chamber.

14. The apparatus of claim 13, wherein the illumination source is configured to direct light through the first reflector and into the interior of the sample chamber, and
wherein the detector is configured to receive light through the second reflector from the sample chamber.

15. The apparatus of claim 10, wherein the illumination source is a light emitting diode.

16. The apparatus of claim detector is a photodiode, a photomultiplier tube, or an avalanche photodiode.

17. The apparatus of claim 10, further comprising at least one sensor on the first substrate, the second substrate, or combinations thereof, wherein at least one sensor is configured to measure temperature, pressure, humidity, or combinations thereof.

18. The apparatus of claim 10, further comprising a controller in electrical communication with the detector and configured to determine a concentration of a target gas in the sample chamber based on the received portion of the illumination light.

19. The apparatus of claim 10, wherein the illumination carrier comprises:
a first illumination carrier component;
a second illumination carrier component;
a first seal positioned between the first illumination carrier component and the first substrate; and
a second seal positioned between the second illumination carrier component and the first substrate,
wherein the first manifold is formed between the first illumination carrier component and the first substrate and the second manifold is formed between the first substrate and the second illumination carrier component.

20. The apparatus of claim 10, wherein the detector carrier comprises:
a first detector carrier component;
a second detector carrier component;
a first seal positioned between the first detector carrier component and the second substrate; and
a second seal positioned between the second detector carrier component and the second substrate,
wherein the third manifold is formed between the first detector carrier component and the second substrate, and the fourth manifold is formed between the second substrate and the second detector carrier component.

21. A method comprising:
directing light from an illumination source through a first reflector and into a sample chamber containing a gas sample;
receiving light at a detector through a second reflector which is at an opposite end of the sample chamber from the first reflector; and
measuring a concentration of a target gas in the gas sample based on the light received by the detector.

22. The method of claim 21, wherein at least a portion of the received light has been reflected between the first reflector and the second reflector one or more times.

23. The method of claim 21, further comprising measuring additional properties of the gas sample with one or more sensors, wherein the additional properties include temperature, pressure, humidity, or combinations thereof.

24. The method of claim 23, further comprising measuring the gas concentration based, in part, on the additional properties.

25. The method of claim 21, further comprising:
collecting the gas sample from a suspected emission source; and
determining if the suspected emission source is emitting the target gas based on the measured concentration.

26. The method of claim 21, further comprising measuring a concentration of methane as the target gas.

27. The method of claim 21, further comprising:
receiving the gas sample through a first port in a first manifold;
passing the gas sample through a circuit board which supports the illumination source to a second manifold;
passing the gas sample from the second manifold into an interior of the sample chamber and from the interior of the sample chamber into a third manifold;
passing the gas sample from the third manifold through a second circuit board which supports the detector to a fourth manifold; and
exhausting the gas sample through a second port from the fourth manifold.

28. The method of claim 21, further comprising reporting the measured concentration of the target gas to an external system.
